(19) United States
(12) Patent Application Publication
(10) Pub. No.: US 2008/0013040 A1
(43) Pub. Date: Jan. 17, 2008

(54) EYEGLASS FRAME

(75) Inventor: Ralph Anderl, Berlin (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: IC! BERLIN BRILLEN GMBH, Berlin (DE)

(21) Appl. No.: 11/697,515

(22) Filed: Apr. 6, 2007

(30) Foreign Application Priority Data
Apr. 6, 2006 (DE) 10 2006 016 297.8

(51) Int. Cl. G02C 5/14

(52) U.S. Cl. 351/121

(57) ABSTRACT

Eyeglass frame comprising one ear piece (4) on both the left and right side, and a frame (1) having one receiving element (2) on both the left and right side for attaching the ear piece (4), one connecting element (7) being respectively provided, the ear-piece side of which faces in the direction of the ear piece (4) in the folded-out state and being relatively short compared to the length of the ear piece (4), and to which the ear piece (4) is pivotably hinged in each case, whereby the connecting element (7) may be locked in a recess (3) in the receiving element (2) by means of locking elements (5, 6).

The present invention relates to an eyeglass frame, in particular an eyeglass frame having a screwless articulated mechanism.

Numerous eyeglass frames are known from the prior art which use different variants of articulated mechanisms. The most common variants are based on a hinge mechanism in which pins which are provided on the frame or mounting cooperate with a corresponding articulating part provided on the frame-side end of the ear piece by pushing the parts one inside the other and pivotably connecting same by use of special screws. In most eyeglass frames, especially those to be used with corrective lenses, the frames are opened and closed by means of a locking block. The lenses may also be attached directly to a frame by screwing screws directly into the lens. For frameless eyeglasses the ear pieces are screwed directly into the lenses by means of connecting pieces.

Since the articulated joint represents the component of an eyeglass frame which is subjected to the highest dynamic stress, for the sake of simplicity numerous approaches have omitted a conventional rotary joint.

Thus, U.S. Pat. No. 3,155,982 proposes an eyeglass in which the ear pieces cooperate directly with the front frame part containing the lenses. For this purpose, the frame-side end of the ear piece is divided into three leaf springs, the center leaf spring contacting the outer edge of the frame part, and the two outer leaf springs, by means of formed hooks at their ends, engaging with openings provided in the main part in the vicinity of the outer edge.

A similar mechanism is known from FR 1009345. In the eyeglass frame disclosed therein, at their ends tapering toward the frame the ear pieces are likewise divided into three leaf springs. On the left and right sides of the frame itself a U-shaped connecting piece is provided whose center part forms an articulated joint in which the end of the center of the three leaf springs, bent in the shape of a hook, engages. The two outer leaf springs are linear along their entire length, and in the folded-out state of the ear pieces the ends of the outer leaf springs come to rest with their side faces against the side of the connecting piece facing away from the eyeglass wearer, and with their end faces come to rest against the surface of the eyeglass frame facing the eyeglass wearer, thereby stabilizing the ear pieces in the folded-out state.

A simpler design is proposed in EP 0 863 424 B1, which integrates the approach of the articulated connection already in the frame or mounting and incorporates the principle of an ear piece provided with three leaf springs. On both the left and right sides of the frame a connecting element is provided which has upper and lower recesses which form an articulating axis running perpendicular to the direction of the folded-out ear piece. In the folded-out state of the ear pieces, the outer leaf springs lie against the surface of the connecting element pointing toward the face of the eyeglass wearer, and at the bends provided at their free ends pass through the recesses in the connecting element, whereas the center leaf spring lies against the oppositely situated face of the connecting element. An articulated joint is thus created in a simple manner which engages directly with the frame and dispenses with conventional types of connections such as screws. The connecting element is divided into two parts, thus allowing lenses to be replaced more easily. All components of such eyeglasses are produced from sheet metal. However, this mechanism has the disadvantage that the mounting or frame must be manufactured from the same material as the connecting elements, since the latter are connected to the frame in one piece.

Proceeding from the above description, the object of the present invention is to provide a connection between a frame and ear pieces which accommodates the previously described articulated mechanism and allows the frame and ear pieces to be selected from different materials.

This object is achieved by use of an eyeglass frame having the features according to claim 1.

The key concept of the invention lies in the fact that a receiving element of the eyeglass frame has a recess, pointing in the direction of the ear piece, in which at least one locking element is provided. This locking element, a notch or projection, for example, cooperates with a corresponding locking element of a connecting element having an essentially complementary shape in order to form a secure connection between same.

In this manner the frame and ear pieces may be selected from different materials without the need to match one to the other.

The receiving element may be provided on the frame in the form of a block, and preferably is connected to the frame in one piece. The recess is, for example, milled into the receiving element.

In one embodiment of the invention, the connecting element has two locking catches or locking indentations inside the recess, oppositely situated as viewed in the vertical direction, which cooperate with two corresponding locking indentations or locking catches for the connecting element having an essentially complementary shape.

Multiple locking elements may also be provided one behind the other in the longitudinal extension of the connecting element, i.e., in the direction facing the ear piece. The recess correspondingly has a row of locking elements having a complementary shape.

In one special embodiment, the connecting element is made of a flat material. The connecting element in particular is made of the same flat material as the eyeglass ear piece, whereas the eyeglass frame may be made of a solid material such as acetate or horn. Sheet metal is suitable as a flat material.

In a further embodiment of the eyeglass frame according to the invention, at the end of the receiving element facing the ear piece vertical groove sections may be provided in which a section of the connecting element may be partially accommodated in order to impart sufficient stability to the connecting element made of a flat material. The outer distance between the groove sections may correspond to the width of the connecting element.

In one particularly preferred embodiment of the eyeglass frame according to the invention the connecting element has an elastic design, at least in the region of the locking elements provided at that location, thereby exerting a corresponding vertical elastic effect which engages the locking elements. The elastic effect is provided by simple means by the fact that in the longitudinal extension the connecting element has two spring tongues at its end facing the receiving element.

The ear piece is hinged to the connecting element, whereby for this purpose an articulated mechanism, known from previously referenced EP 0 863 424 B1, is preferably used.

For this purpose, the connecting element has an upper recess and a lower recess which form an articulated axis extending vertically with respect to the direction of the folded-out ear piece. The end of the ear piece tapering toward the receiving element is divided into three parallel leaf springs. In the assembled state of the eyeglass frame, when the ear piece is folded out the center leaf spring at its free end lies against the surface of the connecting element pointing away from the face of the eyeglass wearer, whereby the outer leaf springs at their free ends initially lie against the surface of the connecting element pointing toward the face of the eyeglass wearer, and then in each case pass through the perpendicular recesses in the connecting element and finally come to rest against the surface of the connecting element pointing away from the face of the eyeglass wearer. The outer leaf springs ideally have bends in the region of their free ends which prevent the ear piece from sliding out of the connecting element and stabilize the ear piece in the folded-together state of the eyeglasses.

The invention is explained in greater detail with reference to the exemplary embodiments illustrated in the accompanying drawings, which show the following:

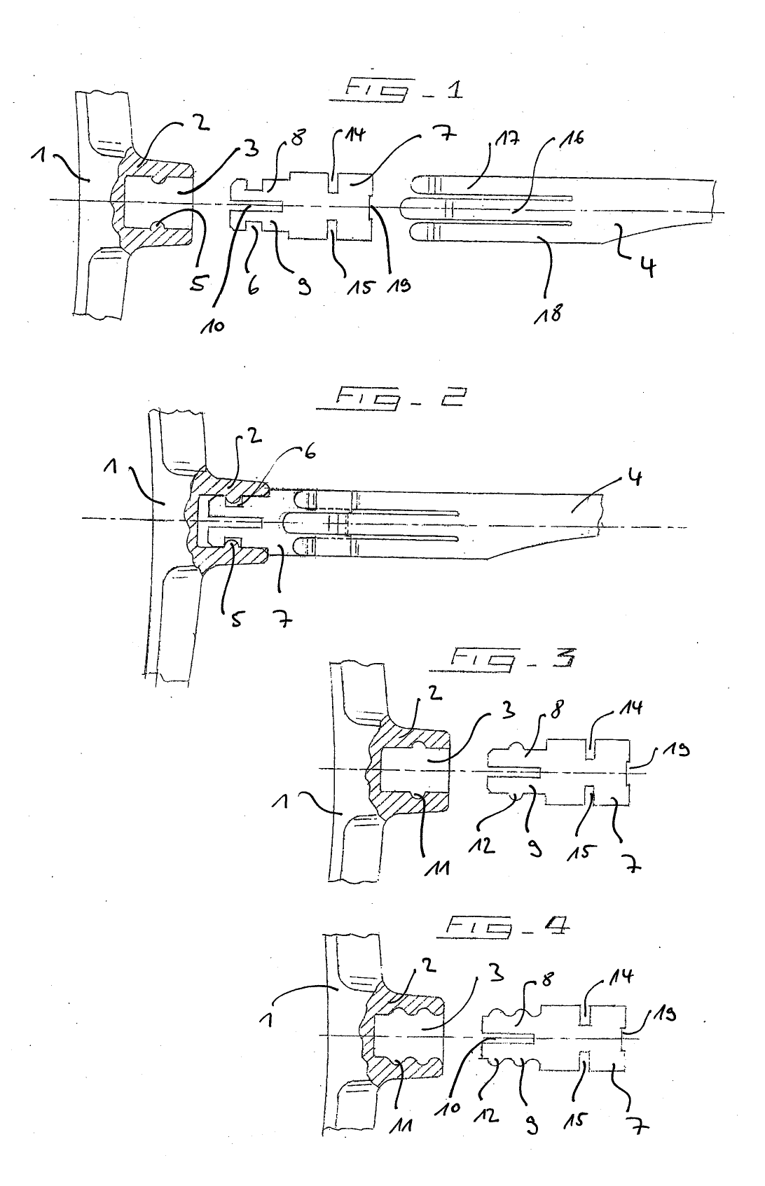

FIG. 1 shows in a schematic exploded view a section of one side of a frame together with a receiving element, a connecting element, and an ear piece;

FIG. 2 shows the elements illustrated in FIG. 1, in the assembled state;

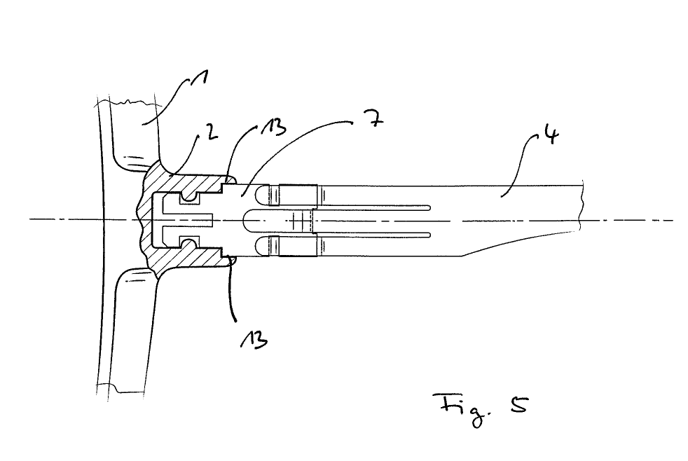

FIG. 3 shows a section of a second embodiment of a connecting element;

FIG. 4 shows a section of a third embodiment of the connecting element; and

FIG. 5 shows a section of a fourth embodiment according to the invention, in the assembled state.

FIG. 1 shows by way of example a sectional view of one side of the eyeglass frame according to the invention, with the elements disassembled.

The eyeglass frame has a frame 1 with a block-shaped receiving element 2, integrally molded in one piece, on each side.

The receiving element 2 projects in a slightly oblique manner from the side of the frame 1, and preferably may have a prism-like shape.

The receiving element 2 has a recess 3 which opens in the direction facing an eyeglass ear piece. The recess 3 may be formed by milling or by casting in the receiving element 2, for example.

As shown in FIG. 1, two oppositely situated locking elements in the shape of projections 5 are provided inside the recess 3 in the receiving element 2.

These locking elements 5 cooperate with corresponding locking indentations 6, designed at least with an essentially complementary shape, which are provided in flanks of a connecting element 7.

The connecting element 7 is made from a flat material, sheet metal, for example, and preferably from the same material as the ear piece 4. The connecting element 7 is inserted into the recess 3 in the connecting [sic; receiving] element 2, whereby the locking elements 5, 6 interlock and thus form a secure connection, as illustrated by way of example in FIG. 2.

To ensure a secure connection, the connecting element 7 has an elastic design at its end facing the receiving element 2, in the region of the locking elements 6, by the fact that two spring tongues 8 and 9 are provided by means of a slot 10 in the sheet metal.

FIGS. 3 and 4 show alternative embodiments according to the invention. FIG. 3 shows the recess 3 [and] two oppositely situated locking indentations 11 which cooperate with locking catches 12 of the connecting element 7 having a corresponding complementary shape. FIG. 4 shows an embodiment in which in each case two such locking indentations 11 are provided in a row in the recess 3 and cooperate with two corresponding, successive locking catches 12 of the connecting element 7.

FIG. 5 shows a further embodiment in which the receiving element 2 of the frame 1 at its end facing the ear piece 4 additionally has oppositely situated vertical groove sections 13 in which a section of the connecting element 7 may be respectively inserted, thereby imparting additional stability.

As shown in FIGS. 1, 2, and 5, the connecting element 7 has an upper recess 14 and a lower recess 15 which are vertically flush, thereby forming an articulating axis.

The ear piece 4 at its end facing the frame 1 has three parallel leaf springs, a center leaf spring 16 and two outer leaf springs 17 and 18.

As shown in FIG. 2, the outer leaf springs 17 and 18 lie against the surface of the connecting element 7 facing the eyeglass wearer, then pass through the recesses 14 and 15 and come to rest at the surface of the connecting element 7 facing away from the eyeglass wearer, whereas the center leaf spring 16 rests on the surface of the connecting element 7 facing away from the eyeglass wearer.

The ear piece 4 may be swiveled in a simple manner, the recesses 14 and 15 forming the articulating axis and the surface of the connecting element 7 facing away from the eyeglass wearer serving as an abutment for the central leaf spring 16 while providing an elastic effect when swiveled. For this purpose the connecting element 7 also has a recess 19 for guiding the central leaf spring 16.

1. Eyeglass frame comprising one ear piece on both the left and right side, and a frame having one receiving element on both the left and right side for attaching the ear piece, one connecting element being respectively provided, the ear-piece side of which faces in the direction of the ear piece in the folded-out state and being relatively short compared to the length of the ear piece, and to which the ear piece is pivotably hinged in each case, characterized in that the receiving element has a recess pointing in the direction of the ear piece and having at least one locking element which cooperates with a locking element of the connecting element having an essentially complementary shape to form a secure connection.

2. Eyeglass frame according to claim 1, wherein two locking catches or two locking indentations are oppositely situated in the recess and correspondingly cooperate with two locking indentations or locking catches of the connecting element having an essentially complementary shape.

3. Eyeglass frame according to claim 1, wherein the connecting element is made of a flat material, in particular sheet metal.

4. Eyeglass frame according to claim 3, wherein the receiving element at its end facing the ear piece has vertical groove sections in which a section of the connecting element may be accommodated.

5. Eyeglass frame according to claim 1, wherein the connecting element has an elastic design in the region of the locking elements.

6. Eyeglass frame according to claim 1, wherein the connecting element has an upper recess and a lower recess which form an articulated axis extending vertically with respect to the direction of the folded-out ear piece.

7. Eyeglass frame according to claim 6, wherein the frame-side end of the ear piece is divided into three parallel leaf springs, and when ear piece is folded out a center leaf spring at its free end lies against the surface of the connecting element pointing away from the face of the eyeglass wearer, and the two outer leaf springs at their free ends initially lie against the surface of the connecting element pointing toward the face of the eyeglass wearer, and then in each case pass through the vertical recesses in the connecting element and finally come to rest against the surface of the connecting element pointing away from the face of the eyeglass wearer.

8. Eyeglass frame according to claim 1, wherein the receiving element is designed as one piece with the frame.
